(19) United States
(12) Patent Application Publication
(10) Pub. No.: US 2005/0262294 A1
(43) Pub. Date: Nov. 24, 2005

(54) Method for policy matching using a hybrid TCAM and memory-based scheme

(76) Inventor: Nabil Bitar, Winchester, MA (US)

Correspondence Address: Lucent Technologies Inc.;Docket Administrator - Room 3J-219, 101 Crawfords Corner Road, Holmdel, NJ, 07733-3030, US

(21) Appl. No.: 10/839,057

(22) Filed: May 5, 2004

(51) Int. Cl. G06F 12/00

(52) U.S. Cl. 711/108

(57) ABSTRACT

The invention defines a TCAM-Memory hybrid scheme that: (1) enables achieving high search rates unattainable with memory-based search alone, and (2) accommodates a large number of policies that cannot be achieved using TCAMs alone. In one exemplary embodiment of the hybrid scheme, an index of the head of an action list based on a fast TCAM search is first determined and then every action in the action list is extracted by memory reference as the actions are organized in the action list. If read latency becomes an issue, every action entry can contain the reference for two or more actions as required to be able to do back-to-back read as opposed to sequential read, reducing the latency problem. Assuming a best match, the TCAM can be configured to return a memory pointer to the head of an action list. Actions are daisy-chained in a strict order in memory and are applied to the packet in the same order. The ability to daisy-chain actions based on one rule saves classification rule entries in expensive TCAMs. This scheme avoids the alternative of having the action itself being returned as a result of the rule match, as this leads to an increase in the number of rules and in the number of searches required per packet.

### FIELD OF THE INVENTION

The present invention relates to communication systems such as routers, switches and firewalls. In particular, this invention relates to the problem of efficiently identifying and applying policies to packets in such systems to influence packet processing.

### BACKGROUND OF THE INVENTION

Communication systems such as routers, switches and firewalls (referred to hereafter as Network Element or NE) are usually required to implement policy systems that enable: (1) the definition of policies that apply to certain packets but not others, and (2) the application of the policies to these packets. A packet, such as an Internet Protocol (IP) packet that is used to transfer data in the Internet, is either generated in the NE, received at the NE from the network or sent to the network by the NE.

There are many resources that limit how many policies can be defined in a system and how many policies can be applied to packets in a unit of time, defined many times, for example, to be second. First, memory resources are required to hold classification rules and action definitions. Second, computational resources are required to form a pattern that can be matched to a rule in order to search the rule database in the classifier and to extract actions and apply them to packets.

Systems today require the ability to define a large number of rules and actions, which stresses memory resources. The ability to apply policies at high data rates also stresses computational resources. There are many ways of building a searchable database. For instance, rules can be organized in a database in memory using a tree structure. Tree-based databases are popular approaches, but they require multiple memory accesses per search imposing requirements on: (1) the processing capability of the processor controlling the searches, (2) memory speed, and (3) the memory-bus bandwidth over which read-commands are sent to memory and data is extracted from memory. For Memory-based searches to be bounded in time, algorithms such as tree balancing, in case of tree-based databases are required. These algorithms complicate and slow down the database management when rules need to be inserted or deleted. In addition, the search computation and bandwidth requirements grow as the rule size grows. Such an approach could be acceptable for certain rule sizes at certain packet rates, but the approach does not scale to large packet rates or large rule sizes. The search problem at high data rates for large rule sizes is a recognized problem that triggered the development of Content Addressable memory (CAM) and Ternary Content Addressable memory (TCAM) technology.

CAMs and TCAMs are hardware search engines with memory that hold the rules to be searched. CAMs have two states whereby the value in a bit in a rule has to be 0 or 1. On the other hand, TCAMs have three states: 0, 1 and wildcard (or Don't Care). Thus, CAMs perform exact matches whereas TCAMs perform best matches. In policy definition, it is important to be able to define a field in a rule as a wild card making TCAMs the most suited to the problem addressed by the present invention.

The number of entries that can be held in a TCAM vary with the rule sizes. TCAMs from leading vendors today can perform more than 50-140 million searches per second, whereby the actual speed in this range varies as a function of rule size and the memory bandwidth into the TCAM. Since the memory in a TCAM is fixed, the larger the rule size, the less the number of rules a TCAM can hold. For a given set of rules that define a classification database, a TCAM-based solution compared to a memory-based solution is: (1) more expensive, (2) more power-consuming, and (3) bigger in footprint. However, search speeds usually require the use of TCAMs. TCAMs are also a popular choice for other applications (e.g., IP address lookup) and are not usually dedicated to policy-based applications. In addition, TCAM entries are usually a scarce resource in an NE since power, space and cost requirements impose a limit on how many TCAMs can be used. Methodologies that enable scaling to large speeds with TCAMs while accommodating a large number of rules are very useful.

### SUMMARY OF THE INVENTION

This invention focuses on a scheme that enables the application of policies to packets once they are defined. The invention defines a TCAM-Memory hybrid scheme that: (1) enables achieving high search rates unattainable with memory-based search alone, and (2) accommodates a large number of policies that cannot be achieved using TCAMs alone. In one exemplary embodiment of the hybrid scheme, an index of the head of an action list based on a fast TCAM search is first determined and then every action in the action list is extracted by memory reference as the actions are organized in the action list. If read latency becomes an issue, every action entry can contain the reference for two or more actions as required to be able to do back-to-back read as opposed to sequential read, reducing the latency problem.

Assuming a best match, the TCAM can be configured to return a memory pointer to the head of an action list. Actions are daisy-chained in a strict order in memory and are applied to the packet in the same order. The ability to daisy-chain actions based on one rule saves classification rule entries in expensive TCAMs. This scheme avoids the alternative of having the action itself being returned as a result of the rule match, as this leads to an increase in the number of rules and in the number of searches required per packet.

### BRIEF DESCRIPTION OF THE DRAWINGS

A more complete understanding of the present invention may be obtained from consideration of the following detailed description of the invention in conjunction with the drawing, with like elements referenced with like references, in which:

FIG. 1 is an exemplary embodiment of a logical policy system included in a data path.

FIG. 2 illustrates an exemplary policy organization scheme in accordance with the present invention; and

FIG. 3 shows an exemplary IP classification rule in accordance with the invention.

### DETAILED DESCRIPTION

Although the exemplary embodiments of the invention are described with regard to packet processing, it would be understood that the same techniques presented here can be applied to problems in computer systems where fast searches are required to identify a list of actions or to a database of information that is required to be searched efficiently. Accordingly, the description of the invention should also be considered applicable thereto.

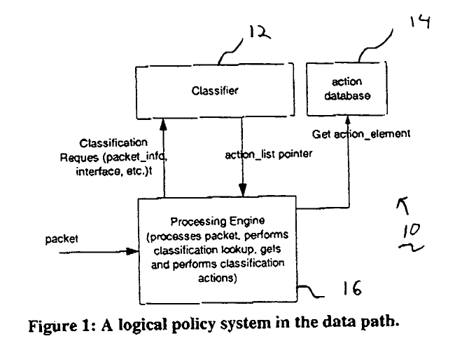

A logical diagram of a policy system 10 in the data path of a packet is shown in FIG. 1. It is usually comprised of a classifier 12, actions 14 and a processing entity 16 that formulate the search and perform the actions. The classifier 12 is used to match on specific packets and identify action(s) to be applied to these packets. It usually consists of a large number of entries or rules. What comprises a rule is dependent on the application and the type of packets being classified (e.g., an IP packet). The classification rules and the actions are populated by a management system that is outside of the scope of this discussion.

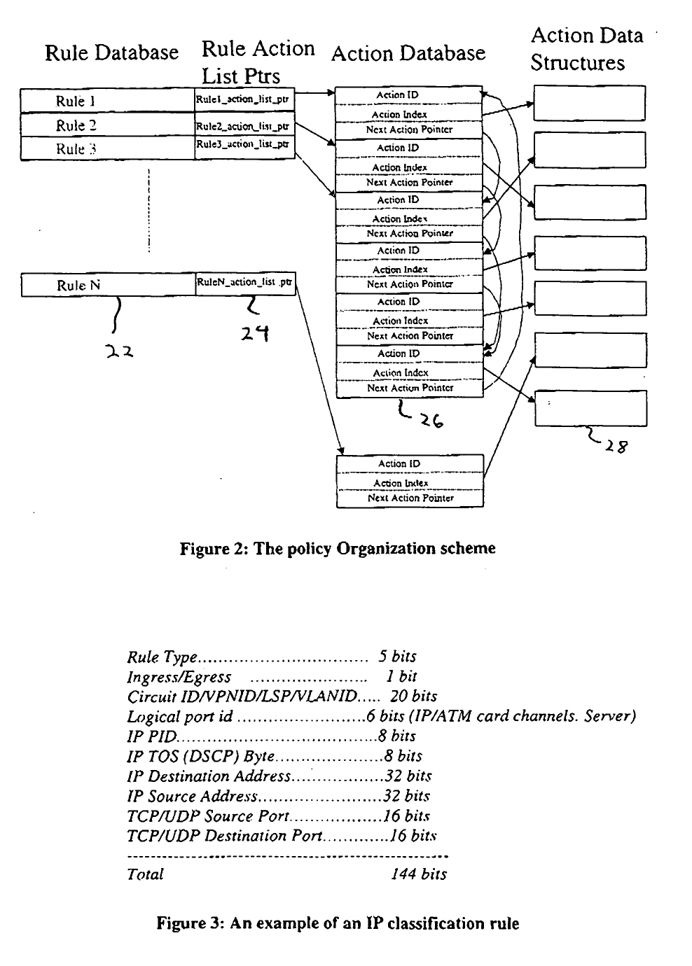

One exemplary embodiment for illustrating the methodology of the present invention is depicted in FIG. 2 in connection with a policy-application scheme. As shown, the methodology includes rules database entries 22, rule action list pointers 24, an action database 26 and action data structures 28. Classification rules and actions comprise the policy management on a network element (NE). Each rule is associated with one or more actions. A rule is stored in a TCAM and identified by a bit pattern and a mask. When a packet is to be classified, a key, comprised of information contained in the packet and/or other information, is used. The key is looked up in the TCAM and matched against a rule. The TCAM search can result in N best matches, where N can be greater than one (1), or no match, i.e., zero. Assuming a best match, the TCAM can be configured to return a memory pointer to the head of an action list. Actions are daisy-chained in a strict order in memory and are applied to the packet in the same order. The ability to daisy-chain actions based on one rule saves classification rule entries in expensive TCAMs. This scheme avoids the alternative of having the action itself being returned as a result of the rule match, as this leads to an increase in the number of rules and in the number of searches required per packet.

The software running on a packet processing engine is responsible for constructing an N-bit wide key from fields in the packet header and other information (e.g., receiving port, circuit ID, etc.) and initiating a search on this key. The format (number and sizes of the fields) of the key is usually software defined and depends on the type of the packet being classified. For instance, an IPv4 classification rule can have the format shown in FIG. 3. Not all fields are required for every rule. When a field is unspecified, it is indicated as wildcard in the mask. In addition, not all types of classifications (e.g., L2 or MPLS classification) will require as big or small of a key. However, variable size rules require dedicating a TCAM bank (refereed to as a logical database) for each key size. Once a bank is allocated to a key size, it cannot be used for another key size. If such a division is not efficient, as it may burn TCAM entries, the rule type in the rule will make the rule unique and disambiguate rules from each other when they happen to have the same values in the other fields albeit they may be semantically different. It can be envisioned that more detailed rules can be needed leading to an increase in size. In addition, IPv6 classification will potentially need a 336-bit key-size. Any key size increase will lead to decreasing the rule capacity of a TCAM. As would be understood, a key size decrease will lead to increasing the capacity. The key sizes do not often have the granularity of 1 bit. That is, they are in multiples of N where N is a basic key-size unit that is usually 36 or 72 bits. Once a match is found, the result will be a pointer to a memory location matched with a given a TCAM entry. That memory location contains a 56-bit action-entry structured, for example, as:
Action ID: 8 bits
Action Index: 24 bits
Next Action Pointer: 24 bits

The location and meaning of the action index will be interpreted in the context of the action ID. For instance, if the action ID is to meter traffic, the action index identifies a packet meter. If the action ID is to encapsulate the packet in a multiprotocol label-switched tunnel (LSP), the Action index points to an entry containing the information about the LSP. The Next Action Pointer, when not NULL, should point to a similar record in memory.

Given the overspeed of TCAM relative to the line rate, it may be possible to perform more than one classification request per packet while keeping up with line rate, while memory access may become the bottleneck. Examples of rule types that can be defined are:
0: IP classification
1: MPLS classification based on an incoming MPLS label.
2: Ethernet classification
3: Point to point protocol over Ethernet (PPPoE) classification
4: Layer 2 tunneling protocol classification

Each rule, based on the rule type, can have a different structure.

Examples of actions:
1: Filter. Drop packet. Following bit should indicate whether to send notification to local CPU
2: IP meter
3: Mark the IP packet, the following bits indicate the DSCP value
4: MPLS policy based forwarding.
5: ATM policy based forwarding
6: Tracing. Following bit should indicate whether a copy is sent to local CPU or to another slot/interface. If sent to local CPU, the following bits are null.

The actions do not have to be adjacent in memory. In addition, different rules can share actions by pointing to the same action memory (i.e., Action Index), further resulting in memory saving.

It is assumed that a control processor unit (CPU) in the control plane will manage the entries and associated data contained in the TCAM and associated memory. Software on the local CPU is responsible for programming the TCAM for the various rule sets as well as the fields associated with matching results for these rules. In programming the rules, it should be kept in mind that the first match will be returned first by the TCAM. This is an implicit priority ordering. Classification can be applied to packets both in the ingress and egress datapath of a packet.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims appended hereto.

1. A method for implementing a policy matching scheme for a computer system including TCAM memory, said method comprising:
providing a policy matching system having a rule database, a rule action list and an action database;
linking actions in a daisy-chain fashion based on a single rule so as to save classification entries.

2. The method of claim 1, wherein said action database includes an action ID, Action index and a next action pointer.

3. The method of claim 2, wherein a location and meaning of the action index are interpreted in the context of the action ID.

4. The method of claim 1, wherein rule types for the rule database are selected from the group consisting of: IP classification, MPLS classification based on an incoming MPLS label, Ethernet classification, Point to point protocol over Ethernet (PPPoE) classification, and Layer 2 tunneling protocol classification.

5. The method of claim 1, wherein actions for said rule types are selected from the group consisting of: Filter or Drop packet, IP meter, Mark the IP packet, MPLS policy based forwarding, ATM or MPLS policy based forwarding, and Tracing.

6. The method of claim 1, wherein different rules can share actions by pointing to a same action memory.

7. A method of reducing the number of TCAM rules for policy matching systems using a hybrid TCAM and memory-based methodology, said method comprising:
determining an index for a head of an action list based on a TCAM search;.
performing each action it eh action list by memory reference as the actions are organized.

8. The method of claim 7, wherein an action entry includes a reference for two or more actions, thereby enabling back-to-back read operations.

9. A method for implementing a policy matching scheme for packets in a network element of a communications network, said method comprising:
configuring a TCAM memory in said network element to return a memory pointer to a head of an action list after determining a best match;
linking actions in an order in memory; and
applying said actions to a packet in a same order as in memory.

10. The method of claim 9, wherein an action includes an action ID, action index and a next action pointer.

11. The method of claim 10, wherein a location and meaning of the action index are interpreted in the context of the action ID.

12. The method of claim 9, wherein rule types for the rule database are selected from the group consisting of: IP classification, MPLS classification based on an incoming MPLS label, Ethernet classification, Point to point protocol over Ethernet (PPPoE) classification, and Layer 2 tunneling protocol classification.

13. The method of claim 9, wherein actions for said rule types are selected from the group consisting of: Filter or Drop packet, IP meter, Mark the IP packet, MPLS policy based forwarding, ATM or MPLS policy based forwarding, and Tracing.

14. The method of claim 9, wherein an action entry includes a reference for two or more actions, thereby enabling back-to-back read operations.
